(19) United States
(12) Patent Application Publication
(10) Pub. No.: US 2018/0293532 A1
(43) Pub. Date: Oct. 11, 2018

(54) CALENDAR CONTROL BASED ON FREE/BUSY CHANGE DETECTION

(71) Applicant: Microsoft Technology Licensing, LLC, Redmond, WA (US)

(72) Inventors: Jaskaran Singh, Sammamish, WA (US); Dipak S. Pawar, Seattle, WA (US)

(21) Appl. No.: 15/481,776

(22) Filed: Apr. 7, 2017

(51) Int. Cl. G06Q 10/06

(52) U.S. Cl. CPC G06Q 10/063116; G06Q 10/06314; G06Q 10/06312

(57) ABSTRACT

When a meeting time for attendees of a meeting is unavailable, a free/busy listener is configured to detect a change in free/busy data for any of the attendees. When the change is detected, free/busy analysis is performed to see whether a meeting time is available. If so, a control signal is generated to control the calendar systems of the attendees in order to schedule the meeting at the identified meeting time.

### BACKGROUND

Computing systems are currently in wide use. Some computing systems run calendar applications (or have calendar functionality) that allow users to perform calendar operations. Such calendar operations can be performed within an electronic mail (e-mail) application, or in a separate calendar application. Calendar operations can include scheduling operations, such as scheduling meetings for one or more attendees, scheduling appointments, etc.

In some computing systems, the calendar application is a hosted application that is hosted in a remote server environment. The hosted application can include a client component that is installed on a client device and that is used to interact with the hosted application and to present a user interface that allows users to interact with their calendars.

Scheduling a meeting with a number of different attendees can present problems. For instance, in one scenario, the user who is scheduling the meeting (the meeting organizer) often needs to access the calendar data for the various attendees in an attempt to identify a free time during a designated time frame. By way of example, if a meeting organizer wishes to schedule a meeting with three other users on Monday next week, then the meeting organizer often needs to access the calendar data for the other three users, corresponding to Monday next week, in an attempt to identify a time when all of the attendees are free for the duration of the meeting. This can be time consuming and cumbersome. Similarly, if no free times are available when the meeting organizer first checks, then the meeting organizer often needs to continue to check back with the calendars for the other attendees to see whether any changes have been made so that a free time opens up during the desired time frame.

When a common time slot or meeting time is not available for all of the attendees, the meeting organizer often goes ahead with scheduling the meeting during a time slot that works for most of the attendees in the hope that the other attendees who had conflicts will adjust their other meetings. This often does not happen, and the meeting organizer needs to reschedule the meeting.

In another scenario, the meeting organizer configures a piece of logic (such as a bot, which is a program that operates as an agent to perform tasks), indicating that the meeting organizer wishes to meet with the identified attendees within a specific time frame (e.g., Monday next week, etc.). The meeting organizer also often indicates the duration of the meeting (e.g., for one hour). The logic then automatically checks to identify whether there is a common slot available, in the specified time frame, in order to schedule the meeting. If so, the logic controls scheduling logic to schedule the meeting in the calendar systems of the attendees. However, if the logic does not find a slot which works for everyone, the logic often simply returns a message to the meeting organizer indicating that no time frames are available, and asking the meeting organizer whether he or she wishes to attempt to schedule the meeting during a different time frame.

All of these current scenarios are relatively cumbersome and time consuming and require a meeting organizer to continue to check for a free time slot within which to schedule the meeting (either manually or using a piece of logic), which is similar to performing a repetitive polling operation. Regardless of whether a piece of automated logic is used, this is time consuming and cumbersome for the meeting organizer.

The discussion above is merely provided for general background information and is not intended to be used as an aid in determining the scope of the claimed subject matter.

### SUMMARY

When a meeting time for attendees of a meeting is unavailable, a free/busy listener is configured to detect a change in free/busy data for any of the attendees. When the change is detected, free/busy analysis is performed to see whether a meeting time is available. If so, a control signal is generated to control the calendar systems of the attendees in order to schedule the meeting at the identified meeting time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing the architecture illustrated in FIG. 1, with some items shown in greater detail.

FIG. 3 is a flow diagram illustrating one example of the operation of the architecture shown in FIG. 1 in configuring a free/busy change listener and controlling a calendar system.

FIG. 4 is a block diagram showing the architecture illustrated in FIG. 1, deployed in a cloud computing architecture.

FIGS. 5-7 show examples of mobile devices, that can be used in the architectures shown in the previous figures.

FIG. 8 is a block diagram of one example of a computing environment that can be used in the architectures shown in the previous figures.

### DETAILED DESCRIPTION

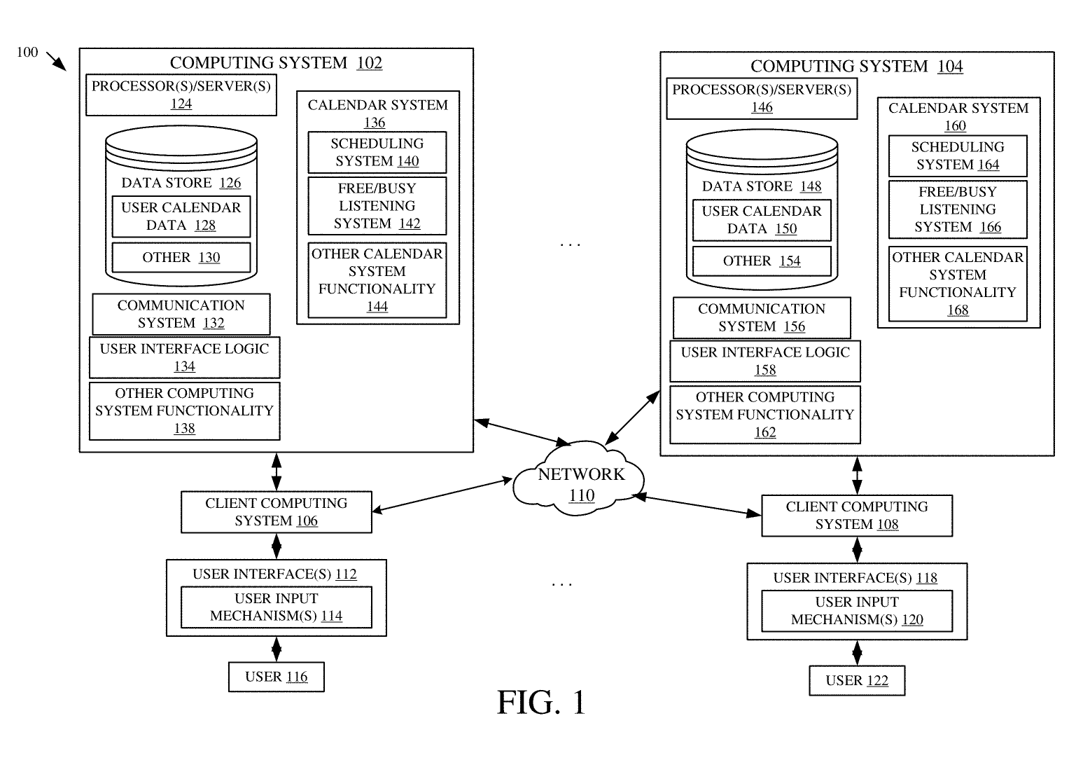

FIG. 1 is a block diagram showing one example of a computing system architecture 100. Architecture 100 includes computing systems 102 and 104 connected for communication to client computing systems 106-108, over network 110. Network 110 can be any of a wide variety of different types of networks, or combinations of networks, including a wide area network, a local area network, a near field communication network, a cellular network, among a wide variety of others.

In the example shown in FIG. 1, client computing system 106 is shown generating user interfaces 112, with user input mechanisms 114, for interaction by user 116. Similarly, client computing system 108 is shown generating user interfaces 118, with user input mechanisms 120, for interaction by user 122. Users 116 and 122 illustratively interact with user input mechanisms 114 and 120 to control client computing systems 106 and 108, respectively, and in order to control some parts of computing systems 102-104.

FIG. 1 shows that, in one example, computing systems 102 and 104 are similar. Computing system 102 illustratively includes one or more processors or servers 124, data store 126 (which can store user calendar data 128 and other data 130), communication system 132, user interface logic 134, calendar system 136 and it can include a wide variety of other computing system functionality 138. Calendar system 136 can include a scheduling system 140, free/busy listening system 142, and it can include a wide variety of other calendar system functionality 144. In the example shown in FIG. 1, the calendar system 136 can be functionality in an electronic mail (e-mail) system, or it can be a separate calendar system. Where it is part of an e-mail system, then user calendar data 128 can be stored in a folder in the user mail box for user 116.

FIG. 1 also shows that, in one example, computing system 104 includes processors or servers 146, data store 148 (which can include user calendar data 150 for user 122 and other items 154), communication system 156, user interface logic 158, calendar system 160, and it can include other computing system functionality 162. Calendar system 160, like calendar system 136, can include scheduling system 164, free/busy listening system 166 and it can include a wide variety of other calendar system functionality 168. Before describing architecture 100, and its operation, in more detail, a brief overview of some of the items in architecture 100, and their operation, will first be provided.

Communication system 132 illustratively allows computing system 102, and other systems, components or logic in computing system 102, to communicate with other systems over network 110. User interface logic 134 can generate interfaces that can be accessed by users 116 and 122 through client computing systems 106-108, or directly. Calendar system 136 illustratively allows user 116 to perform calendar operations. For instance, scheduling system 140 illustratively generates interfaces that allow user 116 to schedule appointments and to generate meeting requests in order to schedule meetings with other users, such as user 122. It also maintains user calendar data 128 which represents the calendar for user 116. Free/busy listening system 142, as will be described below, is configured to detect changes in the calendar data 128 for user 116, during an identified time frame.

For instance, when user 122 uses scheduling system 164 in an attempt to schedule a meeting with user 116 during a specified time frame (such as during “next week”), it illustratively interacts with scheduling system 140 to access the user calendar data 128 for user 116, corresponding to “next week” in order to identify any free times in the user's calendar data that are suitable for the meeting. If a suitable free time (or free time slot) is found, scheduling system 164 illustratively generates control signals to interact with scheduling system 140 in order to schedule the meeting with user 116 (e.g., in order to place the meeting in the user calendar data 128 for user 116). If, however, scheduling system 140 is unable to find any free time slots in the calendar data 128 for user 116 that would be suitable for the meeting (e.g., during the specified time frame and of a suitable duration), then scheduling system 164 illustratively configures free/busy listening system 142 to listen for any changes in the calendar data 128 for user 116, which affect the user's calendar during the specified time frame.

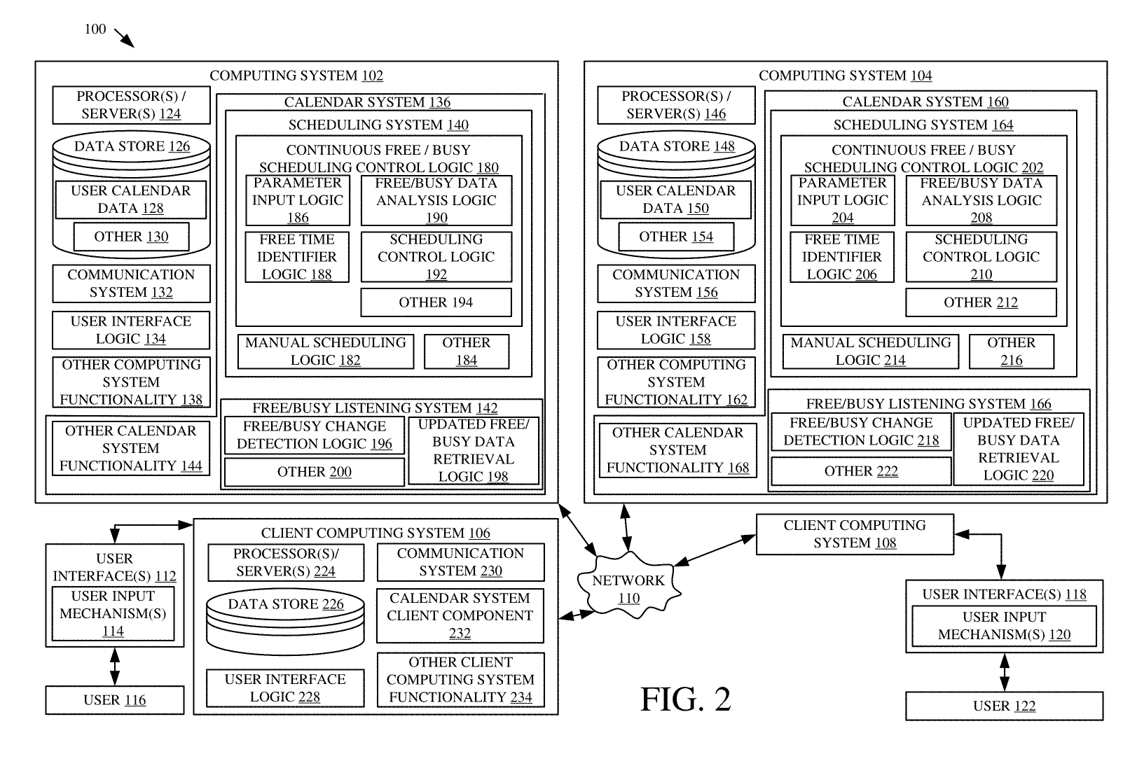

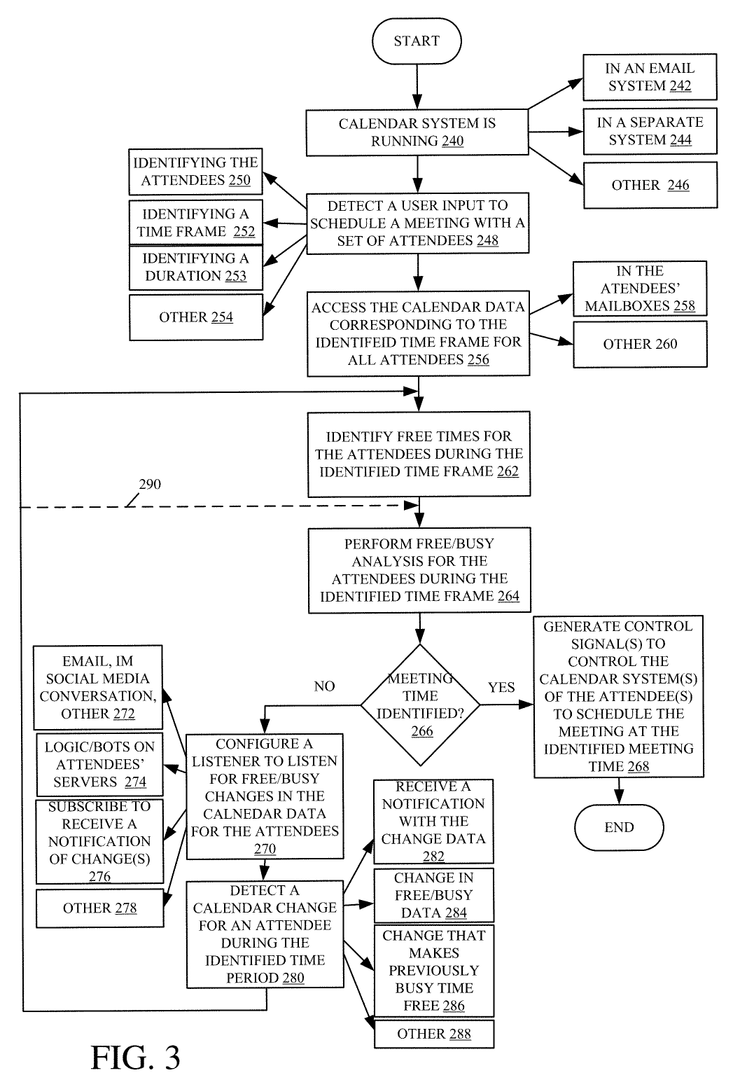

If the calendar data for the specified time frame does change, then this means that the free/busy status of user 116 during that time frame has changed as well. Free/busy listening system 142 will thus receive notice of that change from scheduling system 140, and can provide a communication to scheduling system 164 indicating that the free/busy status of user 116, during the specified time frame, has changed. Scheduling system 164 can then again attempt to schedule the meeting, based upon the new free/busy status of user 116 during the specified time frame. This is discussed in greater detail below with respect to FIGS. 2 and 3.

FIG. 2 is a block diagram showing architecture 100, with the client computing system 106, and calendar systems 136 and 160 illustrated in greater detail, than is shown in FIG. 1. Again, prior to describing the operation of architecture 100 in more detail, a brief overview of the additional items shown in FIG. 2, and their operation, will first be provided.

FIG. 2 shows one example of client computing system 106 in more detail. In the example illustrated, client computing systems 106 and 108 can be the same or different. For purposes of the present description, it will be assumed that they are same so that only client computing system 106 is described in more detail.

In the example shown in FIG. 2, client computing system 106 can include one or more processors or servers 224, data store 226, user interface logic 228, communication system 230, calendar system client component 232, and it can include a wide variety of other client computing system functionality 234. User interface logic 228 in client computing system 106 illustratively generates user interfaces 112 and detects user interaction with user input mechanisms 114. It can provide an indication of that interaction to other items in system 106 or to the other computing systems in FIG. 2. Calendar system client component 232 can be a client component of calendar system 136 and can manage the interaction between client computing system 106 and calendar system 136. Alternatively, client computing system 106 can interact directly with calendar system 136 and other portions of the computing system 102 using communication system 230. Communication system 230 illustratively allows client computing system 106 to communicate over network 110. It can allow communication in other ways as well.

FIG. 2 shows that, in one example, scheduling system 140 illustratively includes continuous free/busy scheduling control logic 180, manual scheduling logic 182, and it can include other items 184. Continuous free/busy scheduling control logic 180 illustratively includes parameter input logic 186, free time identifier logic 188, free/busy data analysis logic 190, scheduling control logic 192, and it can include other items 194. Free/busy listening system 142 illustratively includes free/busy change detection logic 196, updated free/busy data retrieval logic 198, and it can include other items 200.

Similarly, scheduling system 164 illustratively includes continuous free/busy scheduling control logic 202 which, itself, includes parameter input logic 204, free time identifier logic 206, free/busy data analysis logic 208, scheduling control logic 210, and it can include other items 212. Scheduling system 164 can include manual scheduling logic 214 and other items 216. Free/busy listening system 166 illustratively includes free/busy change detection logic 218, updated free/busy data retrieval logic 220, and it can include other items 222.

The scheduling systems 140 and 164 can be similar or different. In the present example, it is assumed that they are similar, and the individual, corresponding items of logic within the two systems operate similarly. Therefore, for purposes of the present description, only scheduling system 140 is described in greater detail. The corresponding items in scheduling system 164 operate in a similar way to those in scheduling system 140.

Manual scheduling logic 182 illustratively generates interfaces that can be interacted with by a user, in order to schedule items on the user's calendar, or on the calendar of other users to which the user has access.

Continuous free/busy scheduling control logic 180 illustratively allows a user or another scheduling system to provide input parameters indicating a time frame within which a meeting is to be scheduled. It then accesses the calendar data for a corresponding attendee to identify free times and analyzes the identified free times to determine whether the attendees of the meeting all have an open time slot within the desired time frame so the meeting can be scheduled. It then automatically schedules the meeting by entering them on the calendars of the attendees. Thus, parameter input logic 186 illustratively exposes an interface that allows a user or another scheduling system to input a time frame within which a meeting is to be scheduled, along with a meeting duration and the identity of the attendees for the meeting. Free time identifier logic 188 illustratively identifies the free times for one or more of the attendees during the time frame and provides those times (as free time data) to free/busy analysis logic 190. Logic 190 analyzes the free time data to determine whether all of the attendees have a free time slot within the identified time frame, of sufficient duration, so that the meeting can be scheduled in the identified time frame. If so, then scheduling control logic 192 illustratively generates control signals to automatically schedule the meeting, such as by placing it on the calendar of the attendees.

If no free time slot is identified by free/busy analysis logic 190 for scheduling the meeting, then free/busy listening system 142 can be configured in order to determine whether there are any changes in the free/busy times for one or more of the attendees. When a change is detected, listening system 142 provides the updated free/busy data (such as an indication of which times have now become free times for a given attendee) to the free/busy data analysis logic of the scheduling logic which was attempting to schedule the meeting. Therefore, free/busy change detection logic 196 illustratively detects when there is a change in the free/busy status of one or more attendees. To do so, it may subscribe to a notification that is generated by scheduling system 140 when there is a change to the schedule for that attendee, during the identified time frame. Thus, logic 196 can be configured to listen for changes in the free/busy data of one or more attendees when that change affects the identified time frame within which time meeting is to be scheduled. When a change is detected, it generates a signal to updated free/busy data retrieval logic 198 that then accesses the calendar data for the attendee for which the change was detected, to retrieve the updated free/busy data for that attendee. In one example, it can retrieve all of the calendar data for that attendee, for the identified time frame, since the calendar data will now include the change. In another example, it only identifies the time periods which were previously busy, but which are now free, due to the change. Retrieval logic 198 provides the updated free/busy data to the scheduling system which was attempting to schedule the meeting. For instance, if user 122 is using scheduling system 164 in an attempt to schedule a meeting with user 116, then when the free/busy status of user 116, during the identified time frame, changes, this will be detected by free/busy change detection logic 196. Updated free/busy data retrieval logic 198 then obtains the new calendar data (or simply the changed free/busy data) for user 116 during the identified time period and provides that information to the free/busy data analysis logic 208 in scheduling system 164. Logic 208 can then run another analysis on the free/busy data for the attendees of the meeting in order to determine whether the newly detected change now opens up a slot during which the meeting can be scheduled. This is described in greater detail below with respect to FIG. 3.

FIG. 3 is a flow diagram illustrating one example of the operation of the architectures shown in FIGS. 1 and 2, in configuring a free/busy listening system 142 to listen for changes in the free/busy data of an attendee and to automatically schedule a meeting with that attendee when a time slot opens up during a specified time frame. FIGS. 2 and 3 will now be described in conjunction with one another.

It is first assumed that the one or more calendar systems in architecture 100 are running. This is indicated by block 240 in the flow diagram of FIG. 3. As briefly discussed above, in one example, the calendar systems 136 and 160 can be inside of one or more e-mail systems for the various users 116-122. This is indicated by block 242. In that scenario, the user calendar data 128 and 150 may be inside a folder in a mailbox in the e-mail system of the corresponding user 116, 122, respectively. In another example, however, the calendar systems 136 and 160 are separate applications or separate computing systems and need not be inside an e-mail system. This is indicated by block 244. The calendar systems can be arranged and running in other ways as well, and this is indicated by block 246.

One of the calendar systems 136, 160 then detects a user input indicating that the corresponding user wishes to schedule a meeting with a set of attendees during a particular time frame. This is indicated by block 248 in the flow diagram of FIG. 3. For purposes of the present description, it will be assumed that user 122 is the meeting organizer and provides an input through a suitable user input mechanism 120 indicating that user 122 wishes to schedule a meeting with at least user 116 as an attendee at the meeting, during a particular time frame (such as during the next week). User 122 thus provides a user input which is communicated to scheduling system 164, indicating this. In one example, the user 122 can use manual scheduling logic 214 to manually search the calendar information 128 of user 116 to identify a free time. In another example, the user provides an input indicating that user 116 is a desired attendee at the meeting, and another input indicating the desired time frame (such as a time frame indicating the following week) and indicating a meeting duration, through parameter input logic 204. Providing an input identifying the attendees is indicated by block 250 and providing an input identifying a time frame within which the meeting is to be scheduled is indicated by block 252. Providing an input identifying a meeting duration is indicated by block 253. User 122 can provide the input in other ways, and the input parameters can include other parameters as well. This is indicated by block 254.

Parameter input logic 124 illustratively provides a signal to free time identifier logic 206 that indicates that user 116 is an attendee, and that also indicates the desired timeframe for the meeting. Free time identifier logic 206 interacts with free time identifier logic 188 in calendar system 136 of user 116 to identify any free times during the identified time frame, on the calendar of user 116. If there is more than one attendee for the desired meeting, then free time identifier logic 206 illustratively interacts with the other items of free time identifier logic in the calendar systems for the other attendees as well, in order to obtain an indication of the free time for those attendees during the desired time frame. Accessing the calendar data corresponding to the identified time frame, for all attendees, is indicated by block 256. Again, the calendar data can be in the mailbox of the attendees, in an e-mail system. This is indicated by block 258. It can be accessed in other ways as well, and this is indicated by block 260. Free time identifier logic 206 thus obtains the free times for all of the desired attendees, during the identified time frame. Identifying the free times for all of the attendees during the identified time frame is indicated by block 262 in the flow diagram of FIG. 3.

This information is provided to free/busy data analysis logic 208. Logic 208 illustratively performs free/busy analysis on the free times to identify whether a meeting time is currently open, for all attendees, during the identified time frame, with a sufficient duration. Performing free/busy analysis is indicated by block 264.

If logic 208 identifies a free time for all attendees, within the identified time frame, and for the specified duration, then a meeting time has been identified. Determining whether a meeting time has been identified, using analysis logic 208, is indicated by block 266 in the flow diagram of FIG. 3. If so, then scheduling control logic 210 generates a control signal to control the calendar systems of the attendees to schedule the meeting at the identified meeting time, on the calendars of those attendees. This is indicated by block 268.

However, if, at block 266, analysis logic 208 determines that there is no meeting time for all attendees during the identified time period, then it illustratively configures free/busy listening system 142 (on the computing systems of all of the attendees) to listen for any changes in the free/busy times or status of the corresponding attendees. For instance, logic 208 can configure free/busy change detection logic 196 by providing it with the identified time frame within which the meeting is to be scheduled. It can provide the meeting duration as well. It can then subscribe to receive notifications when there are any changes to the free/busy status of the user's calendar data 128 for the corresponding user 116. Configuring free/busy change detection logic 196 to listen for these changes, in the calendar system of each attendee, is indicated by block 270 in the flow diagram of FIG. 3.

It will be noted that free/busy analysis logic 208 can configure the free/busy change detection logic 196 on the calendar systems of the various attendees in a variety of different ways. For instance, it can send an electronic mail (e-mail) message to an address corresponding to the free/busy change detection logic 196, to configure that logic. It can also send an instant message or a social media conversation message, or other type of message to the free/busy change detection logic 196 for the various attendees. The messages can include the various information and instructions that logic 196 needs to be configured to listen for the appropriate changes. This is indicated by block 272 in the flow diagram of FIG. 3.

The free/busy change detection logic 196 can be logic or a bot on the attendee's server (e.g., on computing system 102). This is indicated by block 274. The free/busy change detection logic 196 can listen for changes by subscribing to receive the notification discussed above. This is indicated by block 276. The free/busy change detection logic 196 can be configured to listen for changes in other ways as well, and this is indicated by block 278.

At some point, logic 196 will detect a change in the calendar data (or free/busy status) for an attendee, during the identified time frame. This is indicated by block 280 in the flow diagram of FIG. 3. As discussed above, this may be detected by receiving a notification with the change data, indicating what calendar data has changed, during the identified time frame. This is indicated by block 282. In another example, it may be that the calendar system for the attendee has a separate free/busy indicator that indicates the free/busy status of the user for the various slots on the user's calendar. It may do this without showing detailed information about meetings on the calendar, but simply indicate whether the attendee is free or busy during a certain time slot. In that scenario, the change detected may be a notice that the free/busy data for the attendee, during the identified time frame, has changed. This is indicated by block 284.

In another example, it may be that free/busy change detection logic 196 is only configured to listen for changes that make a previously busy time free. For instance, the calendar data (or free/busy status) for a particular attendee may change when the attendee has an additional meeting added during the identified time period. This type of change, however, will not help in scheduling the desired meeting, because no times have opened up. Instead, an additional time has simply become busy. Thus, it may be that the free/busy change detection logic 196 only receives a notice or detects a change that makes a previously busy time free. For instance, if the attendee moves a previously scheduled meeting from one time slot to another time slot within the identified time frame (or where the attendee moves the meeting that was previously in the identified time frame to a slot that is outside the identified time frame), this will change the free/busy status of that attendee, within the identified time frame, by opening up a time slot that was previously busy. In another example, if the attendee cancels a meeting, this will also open up a time slot that was previously busy. Further, if the attendee has marked certain times of the day (such as after 5:00 PM) as being unavailable for meetings, but has changed his or her availability to add more available time, then these are also changes that will be detected. Detecting changes that make a previously busy time free is indicated by block 286. The detected changes can also include all changes, whether they make more or less time available during the identified time frames. All of these and other change detections are contemplated herein. This is indicated by block 288.

Once a calendar change (or free/busy status change) within the identified time frame has been detected, processing again reverts to block 262 where the free times for all of the attendees during the identified time frame are again identified. In another example, where none of the other free/busy times have changed, then the free/busy change that was detected for the particular attendee can be provided to free/busy data analysis logic 208, which can use the times for all of the other attendees that were previously identified, because none of those have changed. Once the free times for all attendees, during the identified time frame are obtained, logic 208 can perform the free/busy analysis to identify a meeting time, if one is now available, given the changed free/busy status of the attendees. This is indicated by the dashed line 290 in the flow diagram of FIG. 3. If so, the scheduling system generates control signals to control the calendar system of the attendees to schedule the meeting as described above with respect to blocks 266 and 268.

It can thus be seen that the present discussion provides a significant improvement to the calendar system itself. By configuring a listener to automatically listen for free/busy status changes for the attendees of a desired meeting, the network bandwidth and processing overhead needed to schedule a meeting is significantly reduced. The user (or another automated bot) need not continuously check the free/busy status of the various attendees to determine whether a time slot has opened up. Nor does the meeting organizer need to schedule a meeting in the hopes that the other attendees will attend, only to cancel the meeting and reschedule for another time. Instead, because the listener is configured to listen for the free/busy status change, the free/busy analysis need only be performed when a change is detected within the identified time frame. All of this reduces the network bandwidth needed to schedule a meeting, the computing overhead used in performing free/busy analysis, as well as the roundtrip communication that occurs between the computing system of the meeting organizer and the various calendars of the attendees. It also greatly enhances the user experience by eliminating the time consuming and cumbersome nature of attempting to schedule such a meeting.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

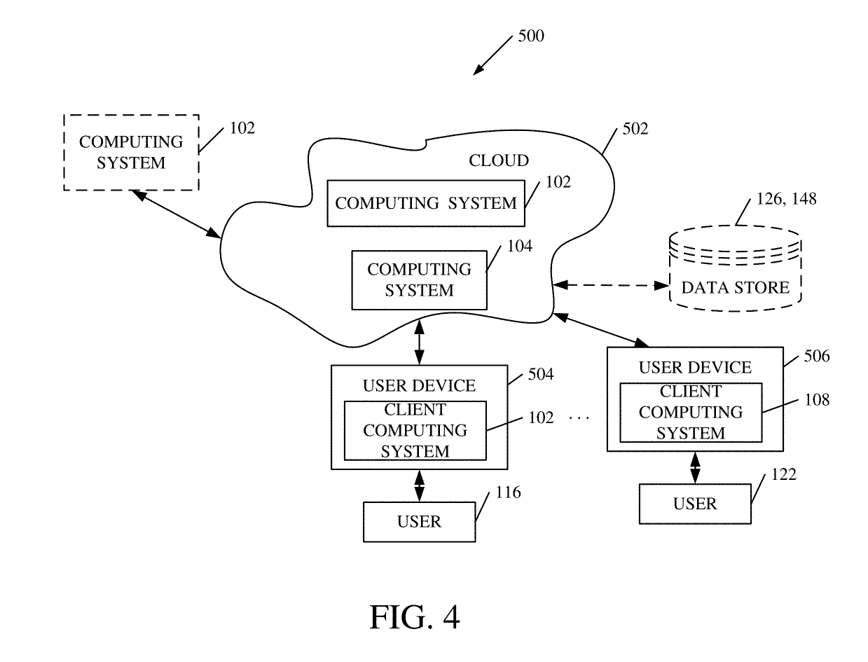

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that computing systems 102 and 104 can be located in cloud 502 (which can be public, private, or a combination where portions are public while others are private). Therefore, users 116-122 use user devices 504-506 to access those systems through cloud 502.

FIG. 4 also depicts another example of a cloud architecture. FIG. 4 shows that it is also contemplated that some elements of architecture 100 can be disposed in cloud 502 while others are not. By way of example, data stores 126, 148 can be disposed outside of cloud 502, and accessed through cloud 502. In another example, either or both of computing systems 102-104, or portions of them, can be outside of cloud 502. Regardless of where they are located, they can be accessed directly by devices 504-506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

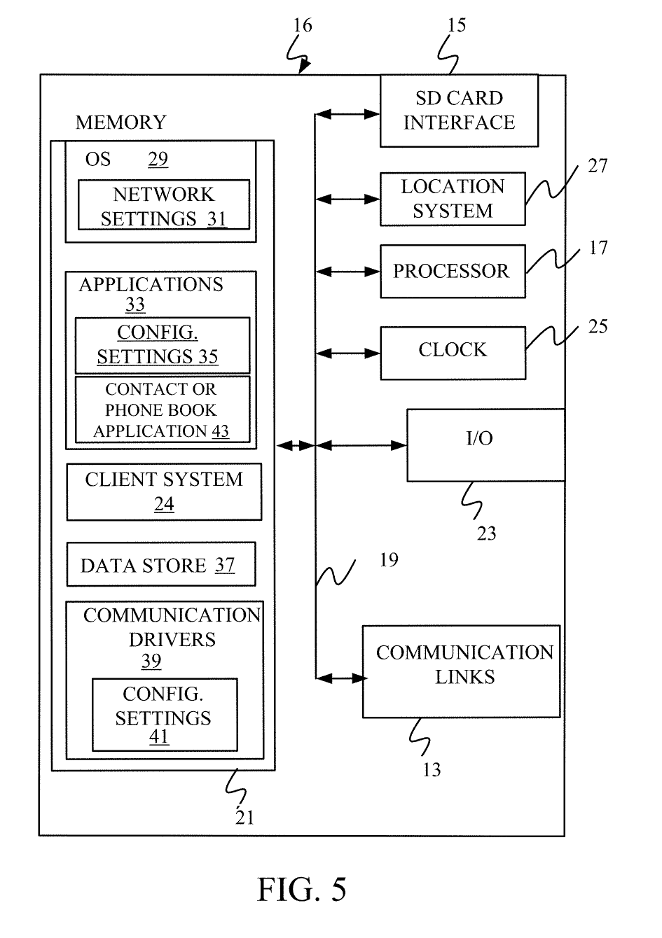

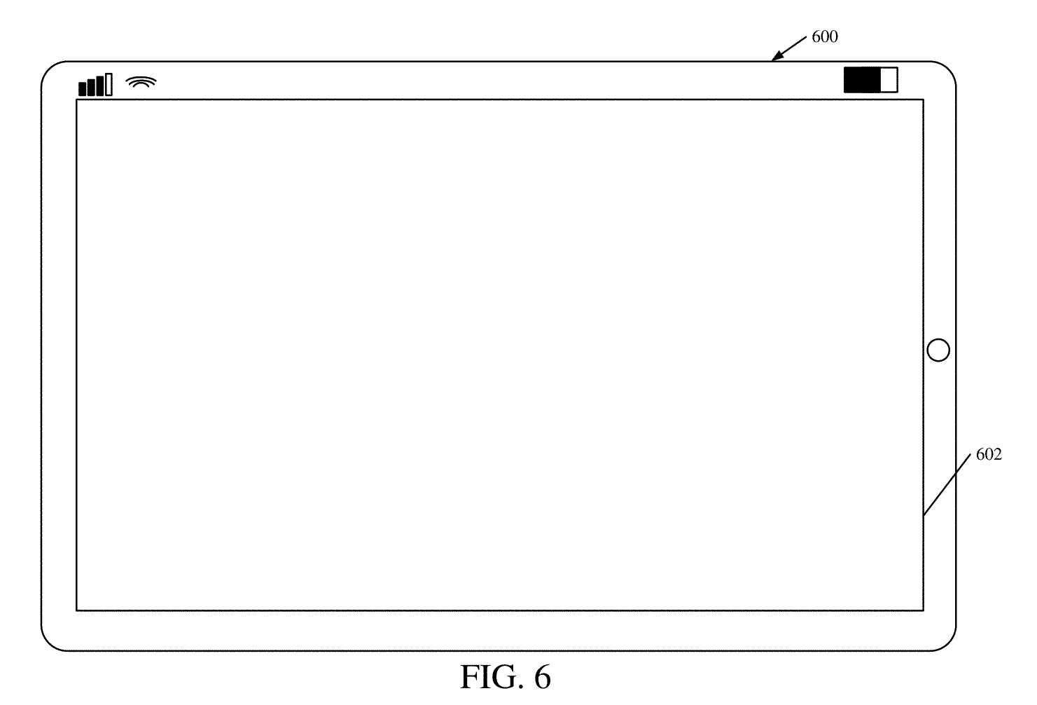

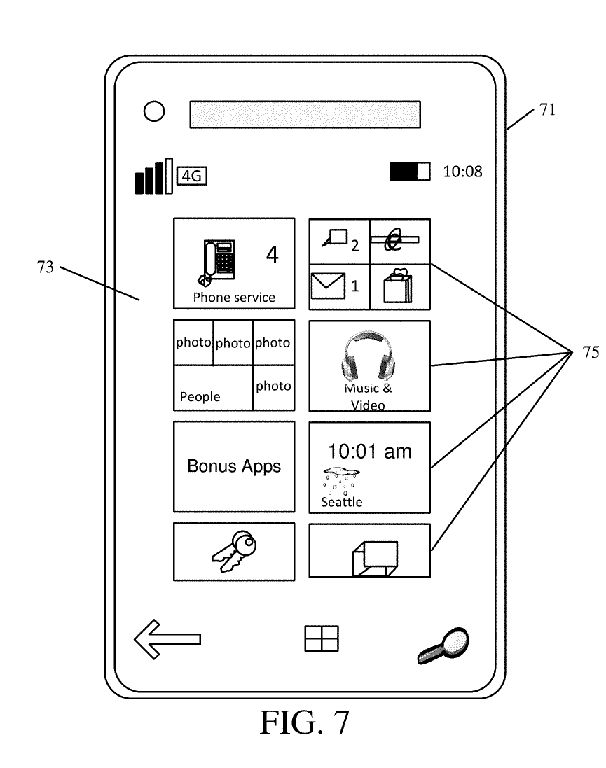

FIG. 5 is a simplified block diagram of one illustrative example of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components of computing system 102, 104, 106 or 108 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers shown in previous FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 7 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

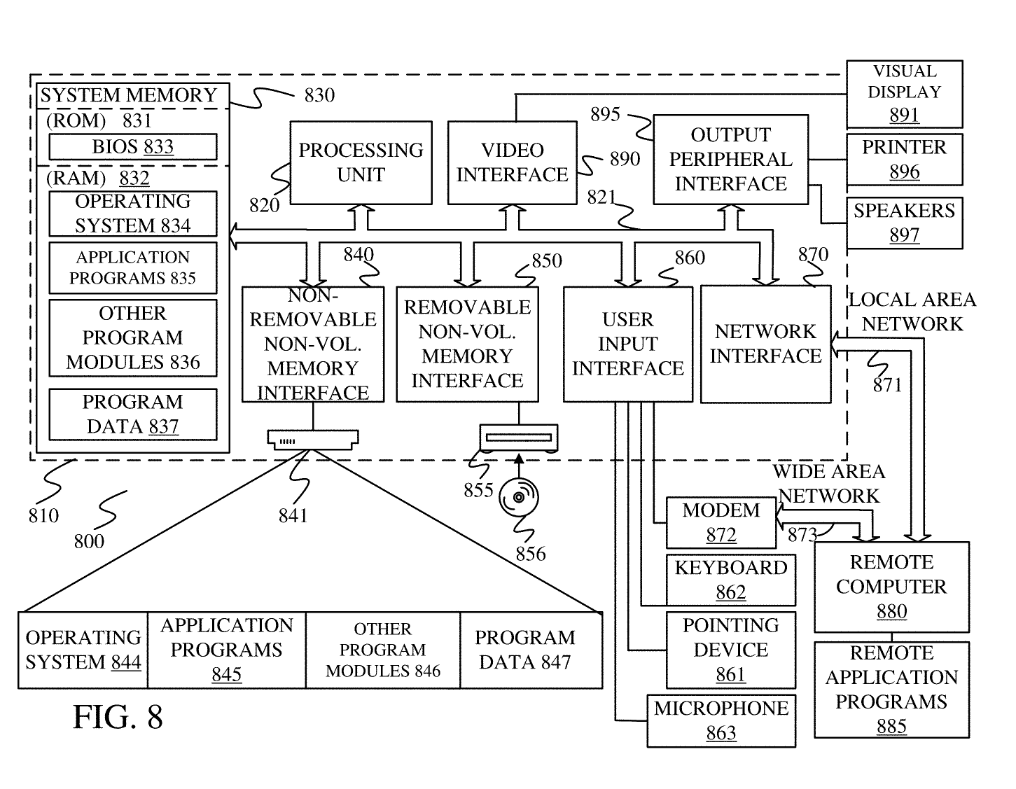

FIG. 8 is one example of a computing environment in which architecture 100, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a calendar system that receives scheduling inputs and generates calendar data indicative of calendar items on a user's calendar based on the scheduling inputs;

a scheduling system that receives a scheduling request for the user, from a requesting system, and accesses the calendar data for the user to identify availability of the user during a time frame identified by the scheduling request, the scheduling system being configured to output a free/busy indicator, to the requesting system, indicative of the availability of the user during the time frame; and

a free/busy listening system that is configured to receive a parameter input indicative of the given time frame and detect changes in the user's calendar during the given time frame and to generate a change signal for the requesting system indicating that the user's calendar has changed during the given time frame.

Example 2 is the computing system of any or all previous examples wherein the calendar system generates a notification indicative of a change in the availability of the user and wherein the free/busy listening system comprises:

free/busy change detection logic configured to receive the given time frame and subscribe to receive a notification indicating that the availability of the user, during the given time frame, changed.

Example 3 is the computing system of any or all previous examples wherein the free/busy change detection logic is configured to generate the change signal only when the availability of the user, during the given time frame, has changed to indicate that a previously busy time during the identified time frame has changed to be available.

Example 4 is the computing system of any or all previous examples wherein the free/busy listening system comprises:

updated free/busy data retrieval logic configured to obtain data identifying the changed availability and provide the obtained data to the requesting system with the change signal.

Example 5 is the computing system of any or all previous examples wherein the updated free/busy data retrieval logic is configured to obtain, as the data identifying the changed availability, free/busy status data indicative of a free/busy status of the user during the given time frame.

Example 6 is the computing system of any or all previous examples wherein the updated free/busy data retrieval logic is configured to obtain, as the data identifying the changed availability, calendar data for the user during the given time frame.

Example 7 is the computing system of any or all previous examples wherein the scheduling system further comprises:

free/busy analysis logic that receives free/busy data, indicative of times when another user is available, and identifies whether the other user is available to attend a meeting within another time frame.

Example 8 is the computing system of any or all previous examples wherein the free/busy analysis logic is configured to configure another set of free/busy change detection logic, in a calendar system corresponding to the other user, to receive the other time frame so that the other set of free/busy change detection logic subscribes to receive a notification indicating that the availability of the other user, during the other time frame, changed and to generate another change signal to the free/busy analysis logic indicative of the changed availability.

Example 9 is the computing system of any or all previous examples wherein the free/busy analysis logic is configured to again identify whether the other user is available to attend a meeting within the other time frame.

Example 10 is the computing system of any or all previous examples and further comprising:

scheduling control logic configured to generate a control signal to control the calendar system corresponding to the other user to schedule the meeting within the other time frame when the other user is available to attend the meeting during the other time frame.

Example 11 is a computer implemented method, comprising:

receiving scheduling inputs;

generating calendar data indicative of calendar items on a user's calendar, based on the scheduling inputs;

receiving a scheduling request for the user, from a requesting system;

accessing the calendar data for the user to identify availability of the user during a time frame identified by the scheduling request;

outputting a free/busy indicator, to the requesting system, indicative of the availability of the user during the time frame; and

configuring a free/busy change listener to detect changes in the user's calendar during the given time frame to generate a change signal for the requesting system indicating that the user's calendar has changed during the given time frame.

Example 12 is the computer implemented method of any or all previous examples and further comprising:

generating a notification indicative of a change in the availability of the user.

Example 13 is the computer implemented method of any or all previous examples wherein configuring the free/busy change listener comprises:

configuring the free/busy change listener to receive the given time frame and subscribe to receive a notification indicating a change in the availability of the user, during the given time frame.

Example 14 is the computer implemented method of any or all previous examples wherein configuring the free/busy change listener to generate the change signal comprises:

configuring the free/busy change listener to generate the change signal only when the availability of the user, during the given time frame, has changed to indicate that a previously busy time during the identified time frame has changed to be available.

Example 15 is the computer implemented method of any or all previous examples and further comprising:

obtaining data identifying the changed availability; and

providing the obtained data to the requesting system with the change signal.

Example 16 is the computer implemented method of any or all previous examples wherein obtaining data comprises:

obtaining, as the data identifying the changed availability, free/busy status data indicative of a free/busy status of the user during the given time frame.

Example 17 is the computer implemented method of any or all previous examples wherein obtaining data comprises:

obtaining, as the data identifying the changed availability, calendar data for the user during the given time frame.

Example 18 is a computing system, comprising:

a calendar system that receives user scheduling inputs and generates calendar data indicative of calendar items on a first user's calendar; and

a scheduling system that sends a scheduling request to a calendar system for a second user, the scheduling request indicating a time frame for a meeting, and to receive a free/busy indicator, from the calendar system for the second user, indicative of the availability of the second user during the time frame, the scheduling system being further configured to generate a configuration signal to configure a free/busy listening system to detect changes in the second user's calendar during the given time frame and to receive a change signal indicating that the user's calendar has changed during the given time frame.

Example 19 is the computing system of any or all previous examples wherein the calendar system further comprises:

free/busy analysis logic that receives, as the change signal, free/busy data, indicative of times when the second user is available, and identifies whether the second user is available to attend a meeting within the time frame.

Example 20 is the computing system of any or all previous examples wherein the scheduling request is a request sent to a plurality of attendees and wherein the free/busy analysis logic is configured to generate a configuration signal to configure free/busy listening system in a calendar system for each of the plurality of attendees to detect changes in any calendars corresponding to any of the plurality of attendees, during the given time frame, and to receive a change signal indicating that any of the calendars corresponding to any of the attendees have changed during the given time frame.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a calendar system that receives scheduling inputs and generates calendar data indicative of calendar items on a user's calendar based on the scheduling inputs;
a scheduling system that receives a scheduling request for the user, from a requesting system, and accesses the calendar data for the user to identify availability of the user during a time frame identified by the scheduling request, the scheduling system being configured to output a free/busy indicator, to the requesting system, indicative of the availability of the user during the time frame; and
a free/busy listening system that is configured to receive a parameter input indicative of the given time frame and detect changes in the user's calendar during the given time frame and to generate a change signal for the requesting system indicating that the user's calendar has changed during the given time frame.

2. The computing system of claim 1 wherein the calendar system generates a notification indicative of a change in the availability of the user and wherein the free/busy listening system comprises:
free/busy change detection logic configured to receive the given time frame and subscribe to receive a notification indicating that the availability of the user, during the given time frame, changed.

3. The computing system of claim 2 wherein the free/busy change detection logic is configured to generate the change signal only when the availability of the user, during the given time frame, has changed to indicate that a previously busy time during the identified time frame has changed to be available.

4. The computing system of claim 2 wherein the free/busy listening system comprises:
updated free/busy data retrieval logic configured to obtain data identifying the changed availability and provide the obtained data to the requesting system with the change signal.

5. The computing system of claim 4 wherein the updated free/busy data retrieval logic is configured to obtain, as the data identifying the changed availability, free/busy status data indicative of a free/busy status of the user during the given time frame.

6. The computing system of claim 4 wherein the updated free/busy data retrieval logic is configured to obtain, as the data identifying the changed availability, calendar data for the user during the given time frame.

7. The computing system of claim 4 wherein the scheduling system further comprises:
free/busy analysis logic that receives free/busy data, indicative of times when another user is available, and identifies whether the other user is available to attend a meeting within another time frame.

8. The computing system of claim 7 wherein the free/busy analysis logic is configured to configure another set of free/busy change detection logic, in a calendar system corresponding to the other user, to receive the other time frame so that the other set of free/busy change detection logic subscribes to receive a notification indicating that the availability of the other user, during the other time frame, changed and to generate another change signal to the free/busy analysis logic indicative of the changed availability.

9. The computing system of claim 8 wherein the free/busy analysis logic is configured to again identify whether the other user is available to attend a meeting within the other time frame.

10. The computing system of claim 9 and further comprising:
scheduling control logic configured to generate a control signal to control the calendar system corresponding to the other user to schedule the meeting within the other time frame when the other user is available to attend the meeting during the other time frame.

11. A computer implemented method, comprising:
receiving scheduling inputs;
generating calendar data indicative of calendar items on a user's calendar, based on the scheduling inputs;
receiving a scheduling request for the user, from a requesting system;
accessing the calendar data for the user to identify availability of the user during a time frame identified by the scheduling request;
outputting a free/busy indicator, to the requesting system, indicative of the availability of the user during the time frame; and
configuring a free/busy change listener to detect changes in the user's calendar during the given time frame to generate a change signal for the requesting system indicating that the user's calendar has changed during the given time frame.

12. The computer implemented method of claim 11 and further comprising:
generating a notification indicative of a change in the availability of the user.

13. The computer implemented method of claim 12 wherein configuring the free/busy change listener comprises:
configuring the free/busy change listener to receive the given time frame and subscribe to receive a notification indicating a change in the availability of the user, during the given time frame.

14. The computer implemented method of claim 13 wherein configuring the free/busy change listener to generate the change signal comprises:
configuring the free/busy change listener to generate the change signal only when the availability of the user, during the given time frame, has changed to indicate that a previously busy time during the identified time frame has changed to be available.

15. The computer implemented method of claim 13 and further comprising:
obtaining data identifying the changed availability; and
providing the obtained data to the requesting system with the change signal.

16. The computer implemented method of claim 15 wherein obtaining data comprises:
obtaining, as the data identifying the changed availability, free/busy status data indicative of a free/busy status of the user during the given time frame.

17. The computer implemented method of claim 15 wherein obtaining data comprises:
obtaining, as the data identifying the changed availability, calendar data for the user during the given time frame.

18. A computing system, comprising:
a calendar system that receives user scheduling inputs and generates calendar data indicative of calendar items on a first user's calendar; and
a scheduling system that sends a scheduling request to a calendar system for a second user, the scheduling request indicating a time frame for a meeting, and to receive a free/busy indicator, from the calendar system for the second user, indicative of the availability of the second user during the time frame, the scheduling system being further configured to generate a configuration signal to configure a free/busy listening system to detect changes in the second user's calendar during the given time frame and to receive a change signal indicating that the user's calendar has changed during the given time frame.

19. The computing system of claim 18 wherein the calendar system further comprises:
free/busy analysis logic that receives, as the change signal, free/busy data, indicative of times when the second user is available, and identifies whether the second user is available to attend a meeting within the time frame.

20. The computing system of claim 19 wherein the scheduling request is a request sent to a plurality of attendees and wherein the free/busy analysis logic is configured to generate a configuration signal to configure free/busy listening system in a calendar system for each of the plurality of attendees to detect changes in any calendars corresponding to any of the plurality of attendees, during the given time frame, and to receive a change signal indicating that any of the calendars corresponding to any of the attendees have changed during the given time frame.
